(19) United States
(12) Patent Application Publication
(10) Pub. No.: US 2016/0178170 A1
(43) Pub. Date: Jun. 23, 2016

(54) FLEXIBLE SUPPORT AND LAMP DEVICE STRUCTURE USING THE SAME

(71) Applicant: iulite GmbH, Koeln (DE)

(72) Inventors: Hans Nopper, Koln/ Cologne (DE); Thomas Lueck, Stuttgart Vaihingen (DE)

(21) Appl. No.: 14/974,548

(22) Filed: Dec. 18, 2015

(30) Foreign Application Priority Data
Dec. 18, 2014 (CN) 201420818293.X

(51) Int. Cl. F21V 21/14; F21V 21/29; F16M 13/00

(52) U.S. Cl. CPC F21V 21/14; F16M 13/00; F21V 21/29; F16M 2200/065

(57) ABSTRACT

A flexible support includes a support member, two steel strips, and two fixing elements. The support member includes a plurality of support elements disposed together. The adjacent support elements are connected by a connection element to cascade the support elements. Two clamp structures are respectively extended from two sides of each support element. Two steel strips are respectively clamped by the clamp structures of the two sides of the support elements. Two steel strips have a spacing therebetween. Two fixing elements are respectively fixed to two terminals of the spacing. A bendable lamp device structure using the flexible support is also disclosed. The lamp cap is stably fastened to the flexible support. The user may bend the support to acquire light sources of differ angles with the lamp cap kept at the same level or direction.

### BACKGROUND OF THE INVENTION

1. Field of the Invention

The present invention relates to a support and a lamp device structure involving the support, particularly to a flexible support and a lamp device structure involving the flexible support.

2. Description of the Prior Art

Lamps are indispensable instruments in living and working. Lamp devices have diversified structures to satisfy different requirements. For example, some traditional lamp devices have bendable supports so as to provide illumination along different directions from different positions. In designing a bendable support of a lamp device, operational convenience and structural stability are the factors the designers should center on.

While the support of a bendable lamp device is curved, the lamp is also rotated or displaced together with the support, which would vary the position and illumination direction of the lamp and may cause inconvenience to the user. If the manufacturers can provide a lamp device whose lamp is not displaced together with the bent support, the lamp device will provide higher usage quality and operational convenience.

### SUMMARY OF THE INVENTION

In order to overcome the problems of the conventional technology, the present invention proposes a flexible support and a bendable lamp device structure involving the flexible support, wherein the flexibility of the support may help the user to curve the support conveniently and acquire a light source projecting from different angles according to requirement, and wherein the lamp cap of the bendable lamp structure is stably fastened to the flexible support, wherefore the lamp cap is not deviated but kept at the same level or the same direction while the flexible support is curved.

According to one embodiment, the flexible support of the present invention includes a support member, at least one first steel strip, at least one second steel strip, and at least two fixing elements. The support member includes a plurality of support elements disposed together. The adjacent support elements are connected by a connection element to cascade the support elements. Each support element has a body with a first side and a second side opposite to said first side. Two clamp structures are respectively extended from the first side and the second side of each support element. The first steel strip is clamped by the clamp structures of the first sides of the support elements. The second steel strip is clamped by the clamp structures of the second sides of the support elements. The first steel strip and the second steel strip have a spacing therebetween. At least two fixing elements are respectively fixedly installed at two terminals of the spacing formed by the first steel strip and the second steel strip.

In a preferred embodiment, each clamp structure has two clamp arms, and a clamping room is formed among the two clamp arms and the body.

In a preferred embodiment, a plurality of fastening elements fastens the first steel strip, the fixing element and the second steel strip together to fixedly install the fixing element in the spacing.

In a preferred embodiment, the fastening element is a screw or an adhesive agent.

According to one embodiment, the bendable lamp device structure of the present invention includes a flexible support, a light emitting module, and a base, wherein the flexible support includes a support member, at least one first steel strip, at least one second steel strip, and at least two fixing elements. The support member includes a plurality of support elements disposed together. The adjacent support elements are connected by a connection element to cascade the support elements. Each support element has a body with a first side and a second side opposite to the first side. Two clamp structures are respectively extended from the first side and the second side of each support element. The first steel strip is clamped by the clamp structures of the first sides of the support elements. The second steel strip is clamped by the clamp structures of the second sides of the support elements. The first steel strip and the second steel strip have a spacing therebetween. At least two fixing elements are respectively fixedly installed at two terminals of the spacing formed by the first steel strip and the second steel strip. One end of at least one fixing element has an extension portion. The light emitting module includes a lamp cap and a light emitting element. The lamp cap is connected with the extension portion of the fixing element and thus fastened to one end of the flexible support. The base is fastened to another end of the flexible support.

In a preferred embodiment, each clamp structure has two clamp arms, and a clamping room is formed among the two clamp arms and the body.

In a preferred embodiment, a plurality of fastening elements fastens the first steel strip, the fixing element and the second steel strip together to fixedly install the fixing element in the spacing.

In a preferred embodiment, a plurality of fastening element fastens the lamp cap to the extension portion of the fixing element and thus installs the lamp cap to the flexible support fixedly.

In a preferred embodiment, the fastening element is a screw or an adhesive agent.

In a preferred embodiment, the light emitting element is light emitting diodes, cold cathode fluorescent lamps (CCFL), or other light emitting elements.

Below, embodiments are described in detail in cooperation with attached drawings to make easily understood the objectives, technical contents, characteristics and accomplishments of the present invention.

### BRIEF DESCRIPTION OF THE DRAWINGS

FIG. 1a is a diagram schematically showing a flexible support according to one embodiment of the present invention;

FIG. 1b is an enlarged view of Region A in FIG. 1a;

FIG. 2a is a sectional view taken along Line I-I′ in FIG. 1b and schematically showing a support element without steel strips;

FIG. 2b is a sectional view taken along Line I-I′ in FIG. 1b and schematically showing a support element with steel strips thereinside;

FIG. 3 is an exploded view schematically showing a terminal of a flexible support according to one embodiment of the present invention;

FIG. 4 is a diagram schematically showing a bendable lamp device structure according to one embodiment of the present invention;

FIG. 5 is a plan view schematically showing a local region of a bendable lamp device structure according to one embodiment of the present invention;

FIG. 6a and FIG. 6b are diagrams schematically showing different operational examples of a bendable lamp device structure according to one embodiment of the present invention.

### DESCRIPTION OF THE PREFERRED EMBODIMENTS

Below, the present invention is further demonstrated in detail with embodiments and corresponding drawings. It should be noted: the embodiments are only to exemplify the present invention but not to limit the scope of the present invention.

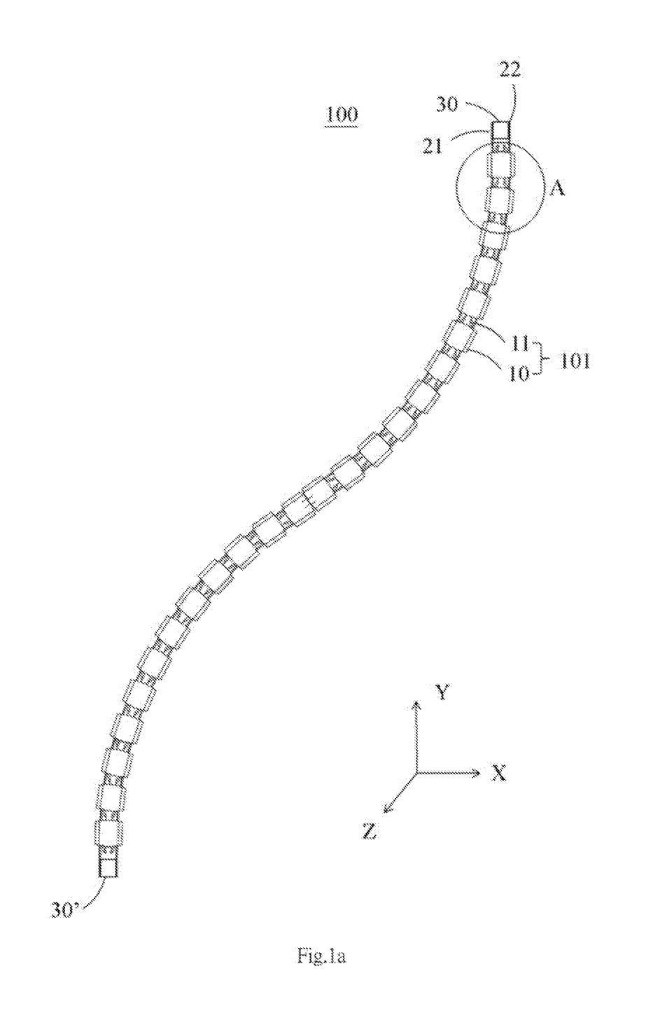

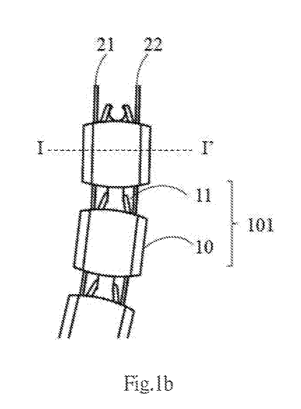

Refer to FIG. 1a and FIG. 1b. According to one embodiment, the flexible support 100 of the present invention includes a support member 101, at least one first steel strip 21, at least one second steel strip 22, and at least two fixing elements 30 and 30′. FIG. 1b is an enlarged view of Region A in FIG. 1a. In order to illustrate the support member 101 concisely, only the support member 101, the first steel strip 21 and the second steel strip 22 are depicted in FIG. 1b. However, the present invention is not limited to have only the support member 101, the first steel strip 21 and the second steel strip 22. As shown in FIG. 1b, the support member 101 includes a plurality of support elements 10 disposed together. The adjacent support elements 10 are connected by a connection element 11. Thereby, the plurality of support elements 10 is cascaded to form a vertebra-like structure. The first steel strip 21 and the second steel strip 22 are insertedly installed inside the support member 101. The fixing elements 30 and 30′ are respectively fixedly installed at two ends of the first steel strip 21 and the second steel strip 22. The configuration of the first steel strip 21, the second steel strip 22 and the fixing elements 30 and 30′ in the flexible support 100 will be described in further detail thereinafter.

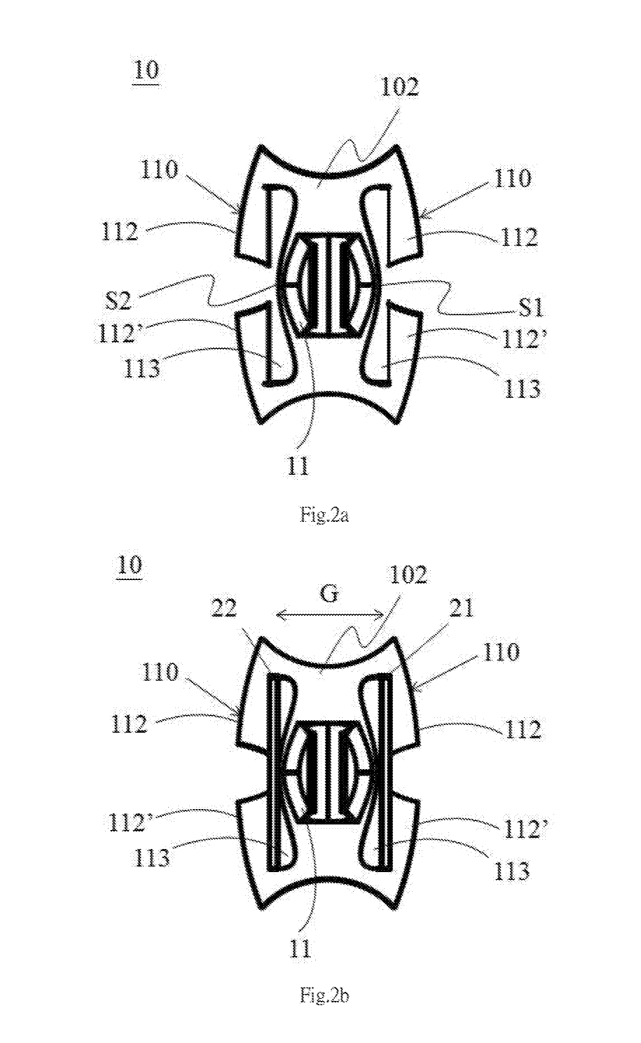

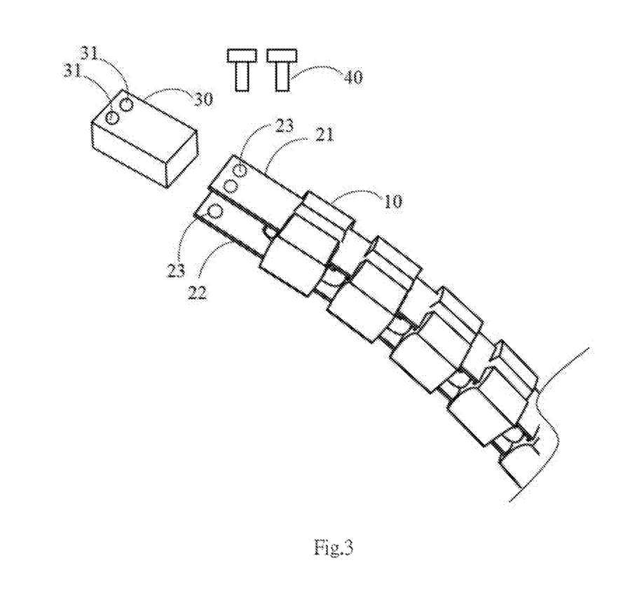

Refer to FIG. 2a. Each support element 10 includes a body 102 having a first side S1 and a second side S2 opposite to the first side S1. Two clamp structures 110 are respectively extended from the first side S1 and the second side S2 of each support element 10. Each clamp structure 110 has two clamp arms 112 and 112′. A clamping room 113 is formed among the two clamp arms 112 and 112′ and each of the first side S1/the second side S2. The two clamping rooms 113 respectively accommodate the first steel strip 21 and the second steel strip 22, as shown in FIG. 2b. In other words, the first steel strip 21 and the second steel strip 22 are clamped to the support element 101 by the clamp structures 110 at two sides of the body 102. Refer to FIG. 1a and FIG. 2b again. In the embodiment, the clamp structures 110 extended from the first sides S1 of the support elements 10 clamp the first steel strip 21, and the clamp structures 110 extended from the second sides S2 of the support elements 10 clamp the second steel strip 22. Thereby, the first steel strip 21 and the second steel strip 22 are oppositely disposed inside the cascaded support elements 10 and have a spacing G therebetween.

The first steel strip 21 and the second steel strip 22 are flexible strips that can be bent or curved arbitrarily. Therefore, the entire flexible support 100 can move 2-dimensionally on the X-Y plane in a waving way.

As shown in FIG. 1a, the fixing elements 30,30′ have a shape corresponding to the shape of the terminals of the spacing G formed by the first steel strip 21 and the second steel strip 22, and the fixing elements 30, 30′ are respectively fixed to the terminals of the spacing G. The assemblage is exemplified with the first fixing element 30 below. As shown in FIG. 3, the terminals of the first steel strip 21 and the second steel strip 22 have a plurality of first fixing holes 23, and the fixing element 30 has a plurality of second fixing holes 31 corresponding to the first fixing holes 23. A plurality of fastening elements 40 are inserted through the first fixing holes 23 and the second fixing holes 31 to fasten the first steel strip 21, the fixing element 30 and the second steel strip 22 together. Thus, the fixing element 30 is fixedly installed inside the spacing G. In FIG. 3, the fastening elements 40 are exemplified by two screws. However, the present invention does not limit that the fastening elements 40 must be two screws. The present invention may have a single fastening element or a plurality of fastening elements. In the present invention, the fastening element may be an adhesive agent or another locking element.

In the flexible support of the present invention, the support member accommodates the two steel strips thereinside to enhance rigidity of the overall structure and favor bending the steel strips; fastening elements fasten the fixing elements, the first steel strip and the second steel strip together at the terminals of the flexible support. Therefore, while the flexible support is curved on the X-Y plane, the bending action would not cause displacement of the steel strips. Thus is greatly improved the utility of the overall flexible support.

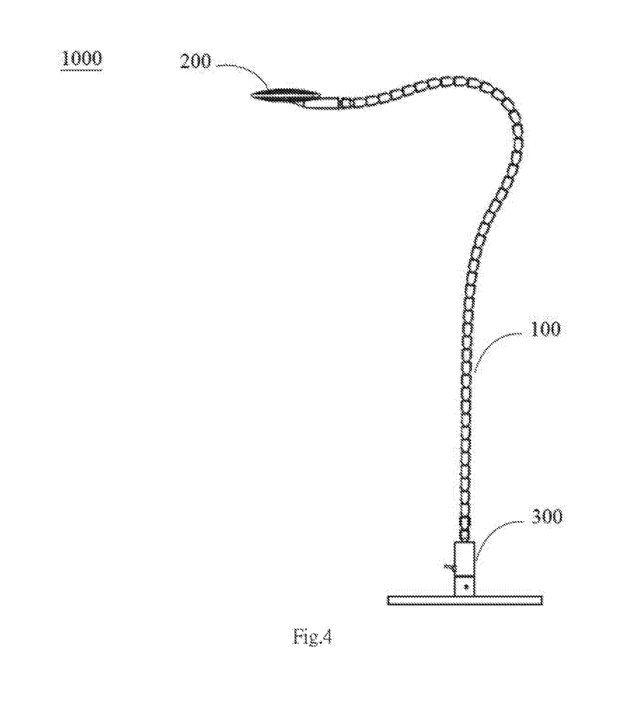

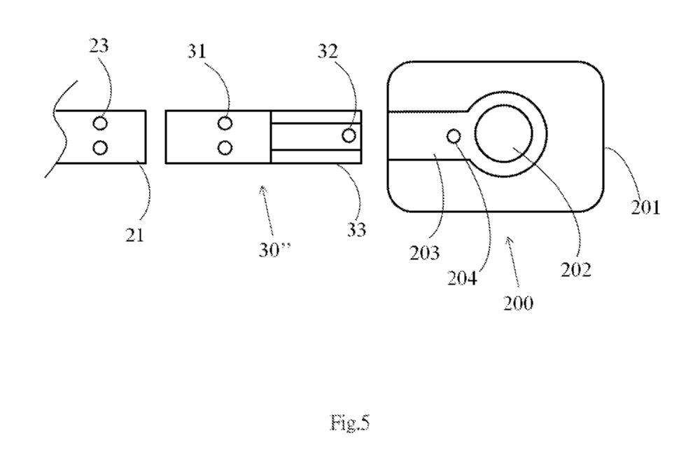

Refer to FIG. 4, one embodiment of the present invention also proposes a bendable lamp device structure. The bendable lamp device structure of the present invention includes a flexible support 100, a light emitting module 200 and a base 300. Refer to FIG. 5. The flexible support 100 is basically similar to that in the abovementioned embodiments. However, this embodiment is different from the abovementioned embodiments in that one end of the fixing element 30″ is fixedly installed in the spacing G between the first steel strip 21 and the second steel strip 22 and that the other end of the fixing element 30″ has an extension portion 33, which is to be connected with the light emitting module 200. In other words, the fixing element 30″ is fastened to the light emitting module 200 and the steel strips 21 and 22 simultaneously. The light emitting module 200 includes a lamp cap 201 and a light emitting element 202. The lamp cap 201 has an accommodation portion 203 corresponding to the extension portion 33 of the fixing element 30″. The accommodation portion 203 has a plurality of third fixing holes 204, and the extension portion 33 of the fixing element 30″ has a plurality of fourth fixing holes 32 corresponding to the third fixing holes 204. The extension portion 33 of the fixing element 30″ can be inserted into the accommodation portion 203 of the lamp cap 201. A plurality of fastening elements (not shown in the drawing) is inserted through the third fixing holes 204 and the fourth fixing holes 32 to assemble the light emitting module 200 to the flexible support 100.

The drawings attached to the specification are only to schematically exemplify the present invention but not to limit the scope of the present invention. For example, the lamp cap 201 may have various shapes and designs to meet different requirements. In one embodiment, the lamp cap 201 has a plate-like structure with a honeycomb-like pattern functioning as a heat-dissipation device of the light emitting module. Although the light emitting element 202 is exemplified by a circular lamp in the drawing, it can be fabricated to have various shapes. The light emitting element 202 may be light emitting diodes, cold cathode fluorescent lamps (CCFL), or other light emitting elements. In the present invention, the base 300 is fixed to another end of the flexible support 100.

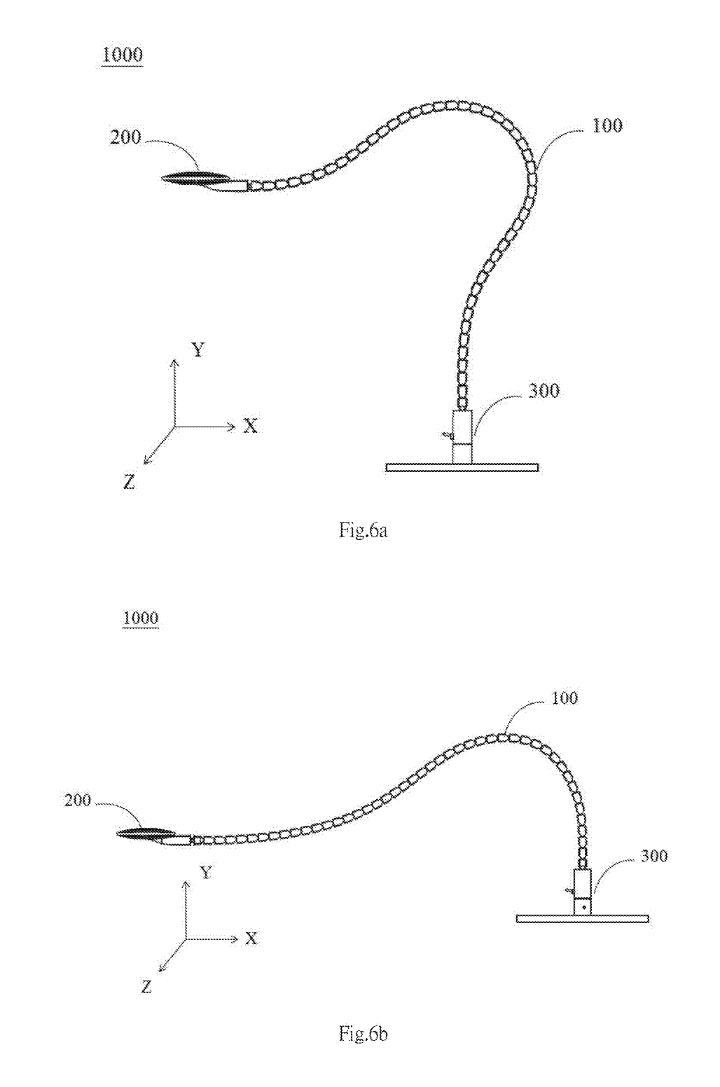

Refer to FIG. 6a and FIG. 6b, according to the description in the abovementioned embodiments, the flexible support 100 can be curved or moved 2-dimensionally on the X-Y plane in a waving way to assume different curvatures. In the present invention, the light emitting module 200 is firmly locked to one terminal of the flexible support 100 by the fixing element 30″. While the flexible support 100 is curved, the light emitting module 200 is not moved together with the flexible support 100 but maintained at the same level or the same orientation. Therefore, the present invention can provide better illumination quality and operation quality.

In summary, the present invention proposes a flexible support, wherein two steel strips are disposed and clamped inside the support member to enhance the stability of the entire support structure, favor bending the steel strips and protect the steel strips, and wherein fastening elements lock the fixing elements and the steel strips at two ends of the flexible support to prevent the steel strips from displacement or dropping off while the steel strips are curved, wherefore is greatly promoted the utility of the flexible support. The present invention also proposes a bendable lamp device structure, wherein the light emitting module is firmly fastened to the flexible support, whereby the light emitting module would not be deviated but will be kept at the same level no matter what curvature the flexible support is bent to have, wherefore the present invention can provide better illumination quality and operation quality.

The embodiments described above are to demonstrate the technical thought and characteristics of the present invention and enable the persons skilled in the art to understand, make, and use the present invention. However, it should be understood: these embodiments are only to exemplify the present invention but not to limit the scope of the present invention. Any equivalent modification or variation according to the spirit of the present invention is to be also included within the scope of the present invention.

What is claimed is:

1. A flexible support comprising
a support member including a plurality of support elements disposed together, wherein said support elements adjacent to each other are connected by a connection element to cascade said support elements, and wherein each said support element has a body with a first side and a second side opposite to said first side, and wherein two clamp structures are respectively extended from said first side and said second side of each said support element;
at least one first steel strip and at least one second steel strip, wherein said first steel strip is clamped by said clamp structures of said first sides of said support elements, and wherein said second steel strip is clamped by said clamp structures of said second sides of said support elements, and wherein said first steel strip and said second steel strip have a spacing therebetween; and
at least two fixing elements respectively fixedly installed at two terminals of said spacing formed by said first steel strip and said second steel strip.

2. The flexible support according to claim 1, wherein each said clamp structure has two clamp arms and that a clamping room is formed among said two clamp arms and said body.

3. The flexible support according to claim 1, wherein a plurality of fastening elements fastens said first steel strip, said fixing element and said second steel strip together to fixedly install said fixing element in said spacing.

4. The flexible support according to claim 3, wherein said fastening element is a screw or an adhesive agent.

5. A bendable lamp device structure, comprising
a flexible support comprising
a support member including a plurality of support elements disposed together, wherein said support elements adjacent to each other are connected by a connection element to cascade said support elements, and wherein each said support element has a body with a first side and a second side opposite to said first side, and wherein two clamp structures are respectively extended from said first side and said second side of each said support element;
at least one first steel strip and at least one second steel strip, wherein said first steel strip is clamped by said clamp structures of said first sides of said support elements, and wherein said second steel strip is clamped by said clamp structures of said second sides of said support elements, and wherein said first steel strip and said second steel strip have a spacing therebetween; and
at least two fixing elements respectively fixedly installed at two terminals of said spacing, wherein one end of at least one said fixing element has an extension portion;
a light emitting module comprising a lamp cap and a light emitting element, wherein said lamp cap is connected with said extension portion of said fixing element and thus fastened to said one end of said flexible support; and
a base fastened to another end of said flexible support.

6. The bendable lamp device structure according to claim 5, wherein each said clamp structure has two clamp arms and that a clamping room is formed among said two clamp arms and said body.

7. The bendable lamp device structure according to claim 5, wherein a plurality of fastening elements fastens said first steel strip, said fixing element and said second steel strip together to fixedly install said fixing element in said spacing.

8. The bendable lamp device structure according to claim 7, wherein said fastening element is a screw or an adhesive agent.

9. The bendable lamp device structure according to claim 5, wherein a plurality of fastening element fastens said lamp cap to said extension portion of said fixing element and thus installs said lamp cap to said flexible support fixedly.

10. The bendable lamp device structure according to claim 9, wherein said fastening element is a screw or an adhesive agent.

11. The bendable lamp device structure according to claim 5, wherein said light emitting element is light emitting diodes, cold cathode fluorescent lamps (CCFL), or other light emitting elements.
